(19) United States
(12) Patent Application Publication
(10) Pub. No.: US 2013/0192718 A1
(43) Pub. Date: Aug. 1, 2013

(54) KIT COMPRISING A LIQUID CONTAINER AND A REFILL DEVICE

(71) Applicants: Jacobus Simon Petrus Van Diepen, Guangdong (CN); Christopher Leonard Padain, Henley on Thames (GB)

(72) Inventors: Jacobus Simon Petrus Van Diepen, Guangdong (CN); Christopher Leonard Padain, Henley on Thames (GB)

(73) Assignee: RECKITT & COLMAN (OVERSEAS) LIMITED, Berkshire (GB)

(21) Appl. No.: 13/695,196

(22) PCT Filed: Apr. 20, 2011
(86) PCT No.: PCT/GB2011/050782

§ 371 Date: Jan. 7, 2013

(30) Foreign Application Priority Data
Apr. 30, 2010 (GB) 1007226.2

(51) Int. Cl. B67D 7/02

(52) U.S. Cl. CPC B67D 7/0294
USPC 141/331; 141/349

(57) ABSTRACT

A kit comprising of a container (20) arranged to be in an inverted configuration and having a cap (21) at its lower end, in use, the cap (21) having an outlet orifice extending axially into the container (20) which is selectively sealed at its axially innermost end by a resiliently biased seal, a disc within the outlet orifice on which the seal sits, a plurality of spokes holding the disc in place, so that, with the seal open, flow paths are formed between the outlet orifice, the disc and the spokes; and a refill device, the refill device comprising a nozzle (41) with a plurality of castellations which fit into the outlet orifice of the container (20) between the spokes to lift the seal from the seat to open a flow path for the ingress of liquid.

The present invention relates to a combination of a liquid container and a refill device. The liquid container is intended for use in a liquid delivery system.

In particular, it is directed to a liquid container for a liquid delivery system described in our earlier application GB 0820981.9.

This earlier application discloses a dispenser comprising a base unit with an actuation mechanism for dispensing liquid and a liquid container insertable to the base in an inverted configuration with its outlet lowermost for the supply of liquid to the base. The liquid container is arranged to be in an inverted configuration and having a cap at its lower end, in use, the cap having an outlet orifice extending axially into the container which is selectively sealed at its axially innermost end by a resiliently biased seal, a disc within the outlet orifice on which the seal sits, a plurality of spokes holding the disc in place, so that, with the seal open, flow paths are formed between the outlet orifice, the disc and the spokes. Such a container will subsequently be described as “of the kind described”.

The base unit comprises a liquid inlet defined by the spigot, a liquid duct leading from the inlet to a liquid outlet above the liquid inlet; a pump pumping the liquid from the liquid inlet to the outlet; a motor to drive the pump; and a shroud extending upwardly in a manner which surrounds the inlet to support the container.

In use, the container is inserted into the base unit in the inverted configuration. A spigot projecting upwardly from the base unit enters the outlet orifice. The spigot has castellations on its upper edge which fit into the outlet orifice between the spokes to lift the seal from the seat to open the flow path for the ingress of liquid into the base.

A sensor in the base unit senses the presence of a user's hands in the vicinity of the outlet and a controller causes the pump to be operated to dispense liquid.

When the liquid in the container is used up, the container is replaced by a fresh one.

The present invention is directed to an alternative to replacing the liquid container with a fresh one.

According to a first aspect of the present invention, there is provided a combination of a liquid container of the kind described and a refill device, the refill device comprising a nozzle with a plurality of castellations which fit into the outlet orifice between the spokes to lift the seal from the seat to open a flow path for the ingress of liquid.

The refill device allows the container to be refilled rather than replaced.

The refill device may be a funnel with the plurality of castellations provided at its outlet. The funnel is inserted into the outlet orifice and liquid to be dispensed is poured into the funnel and hence into the container.

Alternatively, the refill device could be a bottle containing the refill liquid with the plurality of castellations on its outlet nozzle. The bottle may be rigid or may be collapsible, for example, it may be a flexible pouch. If the bottle is rigid, it will require an air relief valve.

The refill device may be configured so that the user aligns the castellations manually with the flow paths. Alternatively, the refill device may be provided with alignment means. This may, for example, take the form of a marking on the refill device providing an indication of its orientation designed to align with the corresponding marking on the liquid container. Preferably, however, if the cap of the container has a non-circular cross-section, the refill device is provided with a cover having a shape corresponding to the cap such that the cover fits over the cap when the refill device is in the correct orientation.

In order to facilitate the filling of the container, the nozzle of the refill device preferably has an air outlet passage and a liquid inlet passage which are separate from one another and are configured to allow air to leave the container as it is filled with liquid.

The present invention also extends to a funnel for use as the refill device in the combination according to the first aspect of the present invention, the funnel comprising a nozzle with a plurality of castellations which fit into the outlet orifice between the spokes to lift the seal from the seat to open the flow path for the ingress of liquid.

Similarly, the present invention extends to a bottle for use as the refill device in the combination according to the first aspect of the present invention, the bottle comprising a nozzle with a plurality of castellations which fit into the outlet orifice between the spokes to lift the seal from the seat to open the flow path for the ingress of liquid.

The funnel or bottle may be provided with the alignment means referred to above.

An example of a combination of a liquid container and a refill device in accordance with the present invention will now be described with reference to the accompanying drawings, in which:

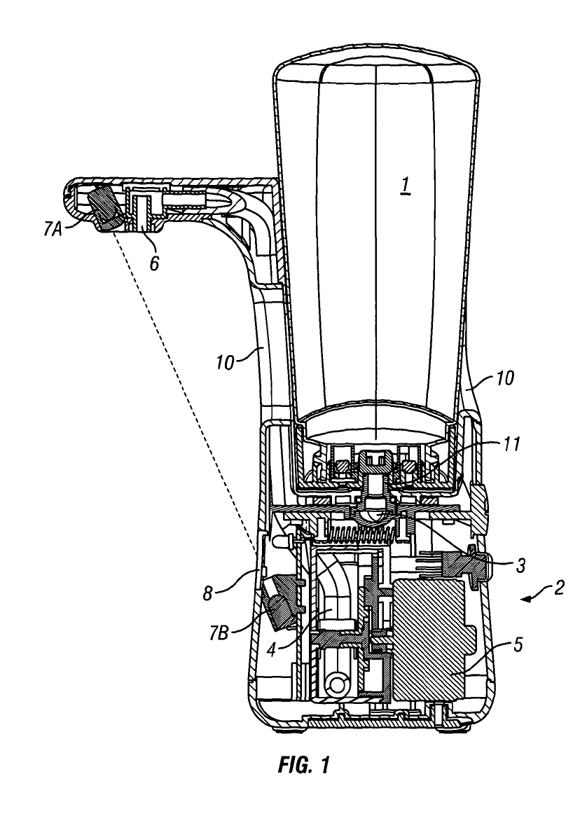

FIG. 1 is a cross-section through a dispenser according to GB 0820981.9;

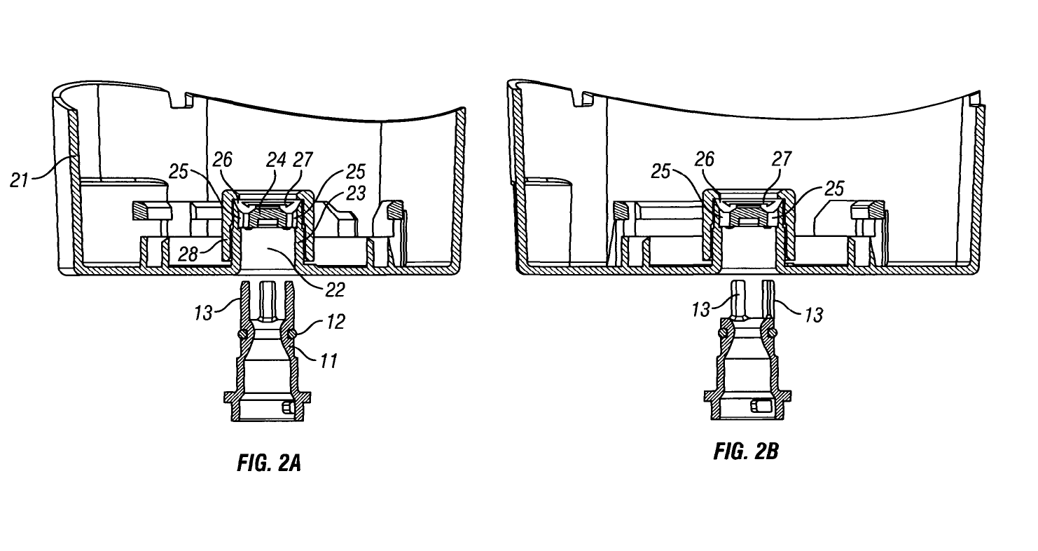

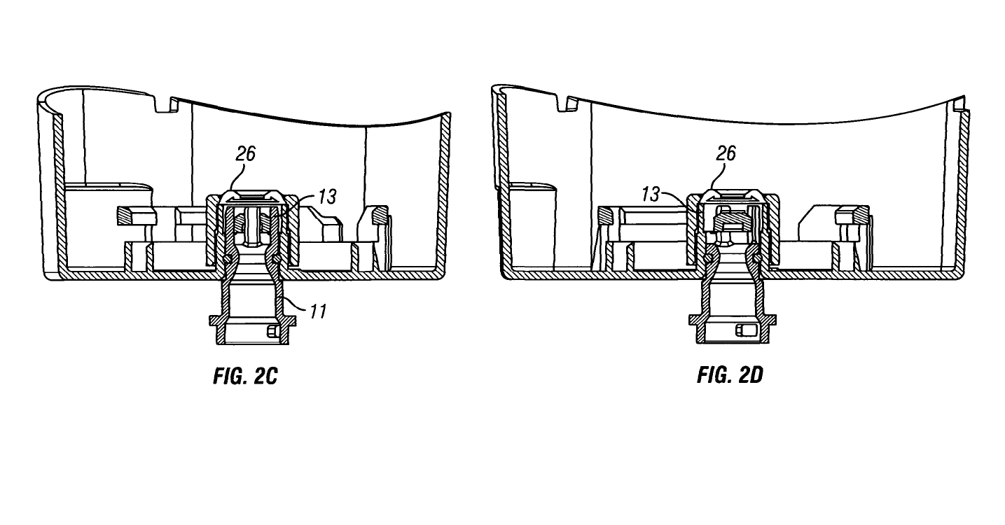

FIG. 2A is a cross-section through the lower part of the bottom of the container and a spigot in the base portion through a first plane;

FIG. 2B is a view similar to FIG. 2A through a plane which is angularly offset from the plane of FIG. 2A;

FIGS. 2C and 2D are similar to FIGS. 2A and 2B respectively with the spigot shown inserted into the container;

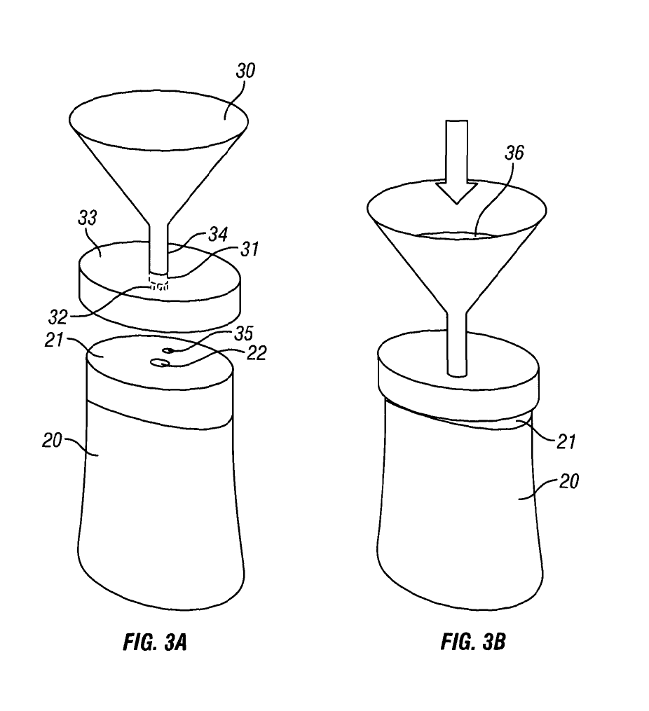

FIG. 3A is a perspective view of a combination of a liquid container and refill device according to a first aspect of the present invention with the refill device in the form of a funnel separate from the container;

FIG. 3B is a view similar to FIG. 3A showing the refill device located on the container;

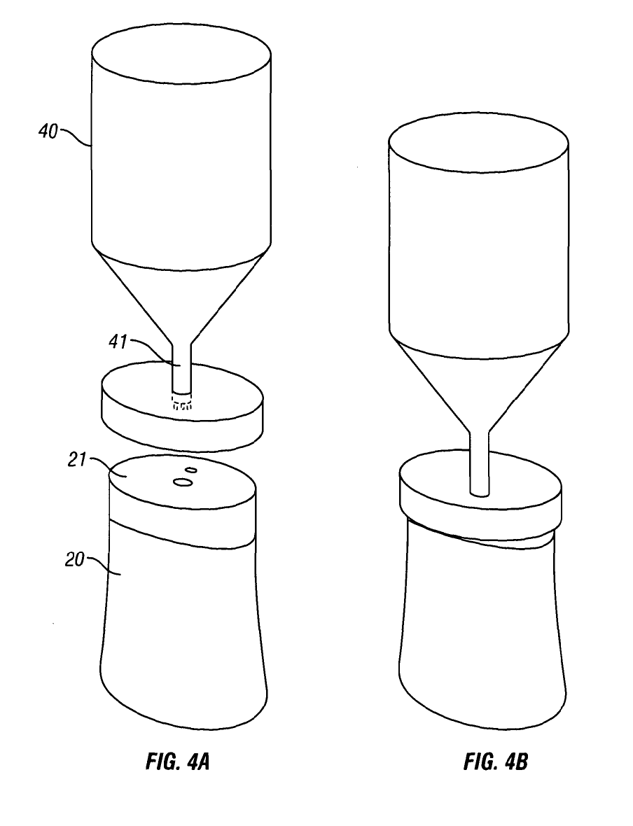

FIGS. 4A and 4B are views similar to FIGS. 3A and 3B with a bottle to provide the refill device.

Before describing the present invention, the operation of the dispenser with the liquid container of GB 0820981.9 will be described for background interest.

The dispenser is a hands-free dispenser which is generally suitable for domestic use. The dispenser is primarily intended to dispense liquid soap, but may also be used to dispense other liquid or semi-liquid products (ideally with a viscosity greater than water), such as hand cream, body lotion, moisturiser, face cream, shampoo, shower gel, foaming hand wash, shaving cream, washing up liquid, toothpaste, acne treatment cream, a surface cleaner or a sanitising agent such as alcohol gel.

The dispenser comprises two main parts, namely a liquid container 1 and a base unit 2. The container 1 provides a reservoir of liquid to be dispensed and is fitted to the base unit 2 as set out below.

The base has an interface 3 into which liquid is dispensed from the refill unit. The interface 3 is in fluid communication with a dispensing tube 4. A pump 5 is selectively operable to pump a metered dose of the liquid along dispensing tube 4 and out of dispensing head 6.

The base has an infrared transmitter 7A which transmits an infrared beam through a window 8 to a receiver 7B to sense the presence of a user's hands in the vicinity of the dispenser. Control circuitry reacts to a signal from the proximity sensor to activate the pump. The illustrated sensor is a break beam sensor, but may also be a reflective sensor. Although an infrared sensor is shown, any known proximity sensor such as a capacitive sensor may be used. The device may be mains powered or battery powered. Alternatively, it may be a manually operated pump device in which a user pushes a lever to displace the product.

The interaction between the base unit 2 and the liquid container 1 will now be described with reference to FIGS. 2A to 2C.

The container comprises a bottle 20 to which a cap 21 is fixed. The bottle is used in an inverted configuration with the cap 21 lowermost as shown in FIGS. 2A to 2D, and is refilled in the opposite configuration with the cap uppermost as shown in FIGS. 3A, 3B, 4A and 4B.

The cap 21 is provided with an inlet 22 in the form of a cylindrical wall. At the top of the cylindrical wall is a valve seat 24 in the form of a disc with a downwardly projecting lip. The disc is held in place by four spokes 25 which are shown in FIG. 2B and partially shown in FIG. 2A reflecting the different planes through which the two cross-sections are taken. The outlet is sealed by an annular seal 26 with a central opening 27. The inner rim of the seal 26 at the central opening 27 seats on the disc 24. The seal is held in place by an annular retaining member 28 which fits over the outer periphery of the sealing element 26 to clamp it in place.

The base 2 is provided with an upwardly projecting spigot 11. This is surrounded by an O-ring seal 12 for sealing with the annular wall 23 and is provided at its upper end with a plurality of castellations 13. These are complementary to the spokes 24.

In use, as the container 20 is fitted into the base, the spigot 11 enters the outlet 22 and pushes the annular seal upwardly as shown in FIGS. 2C and 2D, thereby opening a flow path for liquid to flow from the container into the base.

The present invention is not concerned with the base, but rather with the container 20 and the manner in which it is refilled.

A first example of a refill device is shown in FIGS. 3A and 3B. The refill device comprises a funnel 30 with a nozzle 31 provided at its lowermost end with a plurality of castellations 32 which generally correspond to the castellations 13 of the spigot 11. The funnel is also provided with a cover 33 which is dimensioned to fit over the cap 21. The cover 33 has a hole 34 which corresponds to the position of an air vent 35 on the bottle 20.

In order to refill the container 20, the container is removed from the base 2 and upturned. The nozzle 31 is then pressed into the outlet 22 whereupon the castellations 32 open the valve 26 in the same manner as the spigot 11.

If provided, the cover 33 facilitates the correct location of the funnel on the container and also serves to provide a steady support for the funnel during the refill process. The user then pours liquid 36 into the funnel hence refilling the container.

It will be appreciated that the castellations 32 do not need to correspond exactly to the castellations 13 of the spigot 11. All that is required is that they fit between the spokes 25 and are able to lift the valve element 26 from its seat. In order to do this, there may be fewer castellations 32 on the funnel 30 than there are on the spigot 11.

Once the refill process has been completed, the funnel is removed and the refilled container is returned to the base.

A second example is shown in FIGS. 4A and 4B. In this case, the funnel 30 has been replaced by a bottle 40 with a nozzle 41 corresponding to the nozzle 31 of the funnel including a similar arrangement of castellations and the optional cover.

In order to refill the container 20, the refill bottle 40 is simply upturned as shown in FIG. 4B onto the container to open the flow path and allow liquid to refill the container 20. The refill bottle 40 may be provided with one or more air vents to allow the liquid to flow from the refill bottle without a disruptive effect of air entering through the nozzle 41.

1. A combination of a container arranged to be in an inverted configuration and having a cap at its lower end, in use, the cap having an outlet orifice extending axially into the container which is selectively sealed at its axially innermost end by a resiliently biased seal, a disc within the outlet orifice on which the seal sits, a plurality of spokes holding the disc in place, so that, with the seal open, flow paths are formed between the outlet orifice, the disc and the spokes; and a refill device, the refill device comprising a nozzle with a plurality of castellations which fit into the outlet orifice between the spokes to lift the seal from the seat to open a flow path for the ingress of liquid.

2. A combination according to claim 1, wherein the refill device is a funnel with the plurality of castellations provided at its outlet.

3. A combination according to claim 1, wherein the nozzle of the refill device has an air outlet passage and a liquid inlet passage which are separate from one another and are configured to allow air to leave the container as it is filled with liquid.

4. A combination according to claim 1, wherein the refill device is a bottle containing the refill liquid with the plurality of castellations on its outlet nozzle.

5. A combination according to claim 1, wherein the bottle is a flexible pouch.

6. A combination according to claim 1, wherein the refill device is provided with alignment means.

7. A combination according to claim 6, wherein the cap of the container has a non-circular cross-section, and the refill device is provided with a cover having a shape corresponding to the cap such that the cover fits over the cap when the refill device is in the correct orientation.

8. A funnel for use in a combination according to claim 1, the funnel comprising a nozzle with a plurality of castellations which fit into the outlet orifice between the spokes to lift the seal from the seat to open the flow path for the ingress of liquid.

9. A bottle for use in a combination according to claim 1, the bottle comprising a nozzle with a plurality of castellations which fit into the outlet orifice between the spokes to lift the seal from the seat to open the flow path for the ingress of liquid.
